(19) United States
(12) Patent Application Publication
(10) Pub. No.: US 2011/0176890 A1
(43) Pub. Date: Jul. 21, 2011

(54) DEVICE FOR FORMING THE SPINE OF A CASE OF A BOOK

(75) Inventors: Thomas Friese, Leipzig (DE); Holger Schilling, Bad Mergentheim (DE)

(73) Assignee: MÜLLER MARTINI HOLDING AG, Hergiswil (CH)

(21) Appl. No.: 13/006,314

(22) Filed: Jan. 13, 2011

(30) Foreign Application Priority Data
Jan. 20, 2010 (EP) 10 151 189.7-2304

(51) Int. Cl. B42C 7/00

(52) U.S. Cl. 412/17

(57) ABSTRACT

A device for forming the outstretched, horizontally positioned spine of the case of a book, which is extended uniformly over, and aligned with, the spine of a book block, and which possibly has an inlay such as schrenz paper. The device includes a forming tool, which can be moved toward the inside surface of the spine of the case, i.e., the surface which faces the spine of the book block, lifts the case spine up between two lateral, opposing creasing rails, and produces at least a rounded or flat web on the spine between the book covers of the case. The forming tool is mounted on a rotatable frame having an axis of rotation which is parallel to the creasing rails.

### BACKGROUND OF THE INVENTION

The invention pertains to a device for forming the outstretched, horizontally positioned spine of the ease of a book, which is extended uniformly over, and aligned with, the spine of a book block, and which possibly comprises an inlay such as schrenz paper, the device including a forming tool, which can be moved toward the inside surface of the spine of the case, i.e., the surface which faces the spine of the book block, lifts the case spine up between two lateral, opposing creasing rails, and produces a rounded or flat web on the spine between the book covers of the case. The device includes a one-piece or multi-part forming element, which is parallel to the creasing rails, and which is preferably designed to produce the desired width of the web of the book case spine by means of at least one first and one second subelement, which can be adjusted in common in the direction transverse to their longitudinal dimension to vary the distance between them.

The forming tools of the type in question are those in which, to change the width of the web, the forming elements can be manually replaced, or in which, to change the width of the web, the forming elements consist of multiple parts. Processing with one-piece forming elements is described in conjunction with a casing-in machine in, for example, DE 14 36 086 A and in DE 198 53 254 A1.

Multi-part, i.e., settable and adjustable, forming elements are disclosed in EP 1 350 634 B1, EP 09 405 119.0, and EP 09 405 147.1.

Setup times account for a relatively large percentage of the time required to produce hardcover books. This also applies to the setting-up of the casing-in machine. Especially the installation or replacement of the forming tool in a forming device requires a considerable amount of time.

### SUMMARY OF THE INVENTION

It is here that the invention intends to provide a remedy. The present invention provides a device of the type described above by means of which the economic concerns of a processing company with respect to the production of hardcover books can be improved, so that shorter setup times can be achieved.

According to the invention, the forming tool is mounted on a rotatable frame, which comprises an axis of rotation parallel to the creasing rails.

Thus, books of different thicknesses can be produced as desired, and it is possible to process production orders requiring case spines of different shapes without the need to replace the forming tools or the forming elements.

The rotatable frame can be designed preferably to be rotated either manually or by a motor.

It is advisable for the rotatable frame to be designed so that the forming tools can be replaced easily, as a result of which the device becomes universally applicable.

It is advantageous for the forming tools to be mounted on the rotatable frame in such a way that they are distributed uniformly around the axis of rotation, as a result of which the forming tools can be replaced easily without any noticeable loss of time.

Each of several different or similar forming tools can be connected to its own or a common actuating device.

It is advisable for the actuating devices to comprise a controlled actuating motor, such as a rotational angle-controlled electric motor, which allows the forming tools to be adjusted with precision.

Gear wheel units or traction drives, which allow the precise setting and adjustment of a forming tool, are suitable as actuating devices.

The invention is explained in greater detail below on the basis of an exemplary embodiment by reference to the prior art either already cited or to be cited below and also to the drawing, to which reference is made with respect to all of the details not mentioned in the description.

### BRIEF DESCRIPTION OF THE DRAWINGS

FIG. 1 shows a perspective view of the device according to the invention for forming rounded and/or flat spines of book cases;

FIG. 2 shows a cross section of the device according to FIG. 1, which is in an operating position intended for the production of curved case spines;

FIG. 3 shows a cross section through the device according to FIG. 1, which is in an operating position intended for the production of flat case spines;

FIG. 4 shows a perspective view of the device according to FIG. 3; and

FIG. 5 shows a perspective view of an actuating device for the forming tools of the device.

### DETAILED. DESCRIPTION OF THE INVENTION

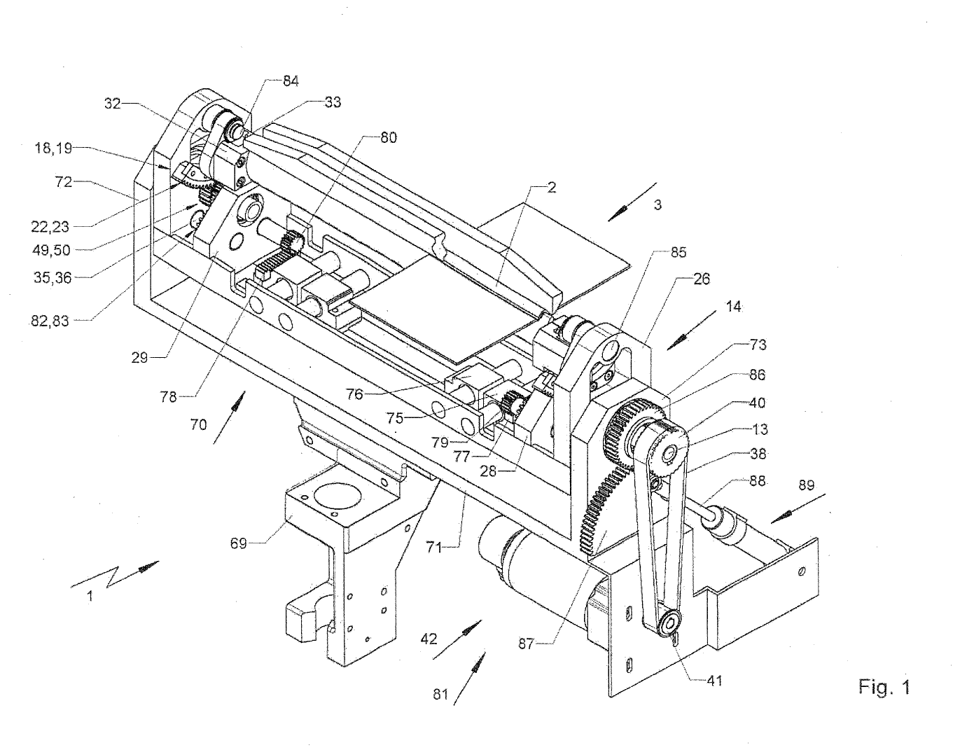

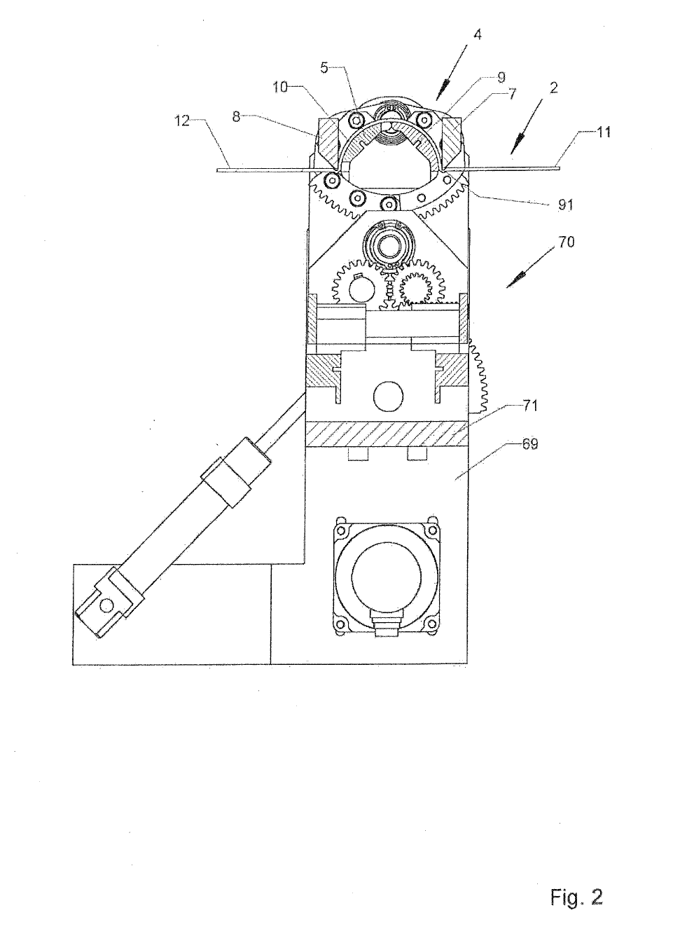

FIGS. 1-4 show a device 1 for forming the rounded or flat spine 2 of a previously outstretched and horizontally positioned case 3 to be provided with a shaped spine 2, the case being extended uniformly over, and aligned with, a book block (not shown), and the spine of the case possibly being provided on the inside surface with an inlay of schrenz paper, for example. For the purpose of forming the spine, the device 1, which is connected by a conveyor toga casing-in machine (not shown), comprises, for example, a device as described in EP 09 405 119.0 for the production of books with cases with curved spines 2, for which purpose an adjustable forming saddle 5 is provided as the forming tool, which extends in the direction perpendicular to the plane of the drawing in FIG. 2 and forms a rounded surface, which can be raised up against the downward-facing, inside surface of the spine 2 of the case, thus lifting it upward, and then lowered back to its original position again.

FIGS. 1 and 2 do not show the forming saddle 5 in the lowered position. Approximately at the level of the case 3, there is a creasing rail 7, 8, also called a creasing bar, on each side of the raised or lowered forming saddle 5. The rails oppose the movement of the forming saddle 5, and the case 3 is thus deflected around them, which results in the rounding of the spine 2 of the case and the formation of the creases or hinges. The forming saddle 5 comprises two downward-slanting saddle blades 9, 10, which, during the forming process, lift the spine 2 of the case out of its flat, horizontal position so that the spine acquires a rounded shape. As a result of this rounding, the book covers 11, 12 of the case 3, which are hinged to the spine 2, are drawn inward from their initial positions. To assist the forming process, the creasing bars or rails 7, 8 can be designed to be heatable. The saddle blades 9, 10 of the forming saddle 5 are adjustable or settable, so that the saddle can be used for the cases of any book and thus for books of any thickness. To this end, each saddle blade 9, 10 comprises a variably rounded or curved surface, which, during the rounding process, gives the spine 2 a regular shape. For this purpose, the saddle blades 9, 10 are designed to pivot around an axis parallel to the longitudinal dimension of the spine of the book block or case spine 2, wherein this pivot axis is located preferably above the book block to be made into a book or above the horizontally outstretched case. At least during the forming process, the saddle blades 9, 10 form a closed, almost completely smooth surface, so that no marks will be produced when the spine 2 is formed. The downward-pointing ends of the saddle blades 9, 10 which form the creases or hinges of a book cover 3, can be driven jointly both toward and away from each other—approximately in the horizontal direction, so that the forming saddle 5, as shown in FIG. 2, can be set up or adjusted for a maximum book thickness with maximum rounding or, as can be seen in FIG. 1, for a minimum book thickness with the minimum rounding of the spine 2.

A manually operated or motorized actuating device 15 is provided to set or to adjust the device 1, which is installed in a frame 14. The pivoting movement of the saddle blades 9,10 is accomplished by means of segment-like drive elements 16-19, to which the saddle blades 9,10 of the forming saddle 5 are attached. Each of the approximately quadrant-shaped drive elements 16-19 has a gear rim 20-23 on its periphery.

The saddle blades 9, 10 of the forming saddle 5 comprise several channels, in which heating lines are mounted to heat the saddle blades 9, 10, wherein these heating lines are preferably inserted electrical heating wires.

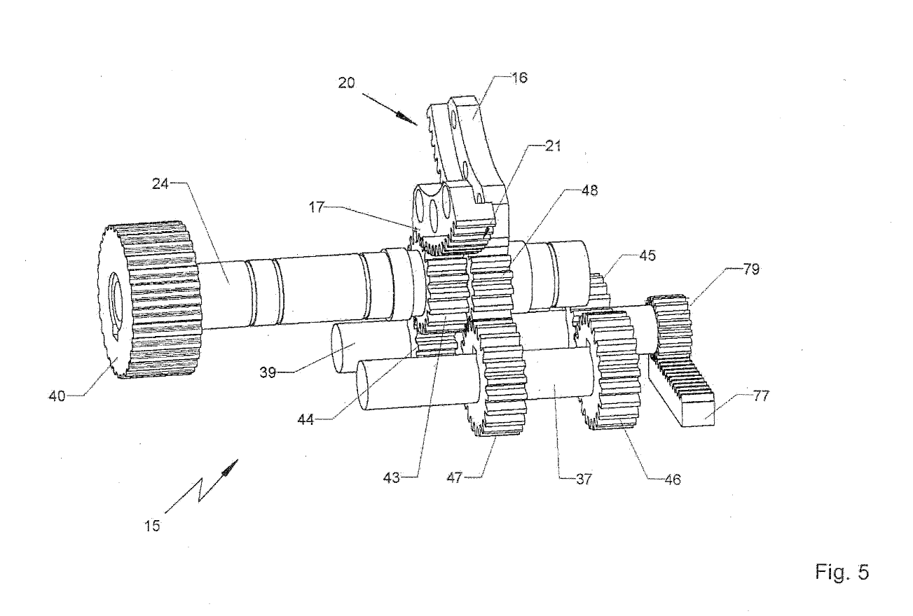

To set and to adjust the forming tools arranged in the frame 14, a manually operated or, as shown in FIG. 5, a motorized actuating device 15 is provided. The pivoting movements of the saddle blades 9, 10 are accomplished in each case by segment-like drive elements 16, 17, to which the saddle blades 9, 10 are attached. Each of the approximately quadrant-shaped drive elements 16, 17 comprises a gear rim 20, 21 on the periphery. Gear rim 21 of the drive segment 17 meshes with the gear wheel 43, which is mounted on the drive shaft 24, which comprises a drive wheel 40, around which passes a drive belt 38, which is connected to and driven by a pulley 41 of a rotational angle-controlled electric motor 42. The gear wheel 43 also meshes with the gear wheel 44, mounted on a countershaft 39. As a result, an additional gear wheel 45 on the countershaft is driven, which drives a gear wheel 46 of a parallel intermediate shaft 37. A drive wheel 47 seated on the intermediate shaft 37 drives an intermediate wheel 48 rotating on the drive shaft 24, and is connected to the drive segment 16. By changing the rotational direction of the controlled electric motor 42, the drive segments 16, 17 are moved toward or away from each other and thus change either the form of the rounding on the forming saddle 5 or, as will be described later, the width of the web formed by the support elements 53, 54 of the forming tool 51 for producing flat book case spines 2.

The forming tools 4, 51 are driven from only one end of the device 1. The drive segments 18, 19 arranged on the opposite side of the device 1 are driven via the saddle blades 9, by means of an identical or similar actuating device 15. The drive segments 18, 19 mesh with the gear wheels 49, 50 mounted on a shaft (not visible), these gear wheels meshing in turn with the gear wheels 82, 83 mounted on the countershafts 35, 36. The countershafts 35, 36 are mounted rotatably in the end caps 27, 29 like the countershaft 39 and the intermediate shaft 37 on the drive side of the device 1, where they are supported in the end caps 26, 28.

The drive segments 16, 17 are supported pivotably on a bearing journal 85 mounted in the end caps, and the drive segments 18, 19 similarly on the bearing journal 84. The saddle blades 9, 10 are connected to the drive segments 16-19 by connecting blocks 30-33, wherein it is also conceivable that the drive segments 16-19 could be connected directly to the saddle blades 9, 10.

FIG. 2 shows the device 1 with the forming saddle 5 in the raised position for the maximum rounding of the book case spine 2 between the creasing rails 7, 8. Each of these creasing rails 7, 8 defines a plane of action 91 with respect to the point in the book cover 11, 12 where the crease is produced. The forming tool 4 consists of at least one forming element 5, which extends parallel to the creasing rails 7, 8 and which is formed by at least one first and one second subelement, which can be adjusted to set the width of the web of the spine of the book block casing. These subelements consist of saddle blades 9, 10; the edges of the blades which abut against each other are designed in the form of intermeshing rakes.

The horizontal plane formed by the axis of rotation 13 of the rotatable frame 14 (see FIG. 1) is parallel to the plane of action 91 of the creasing rails 7, 8 and/or in addition the vertical plane formed by the axis of rotation 13 of the rotatable frame 14 is equidistant from the creasing rails 7, 8 along their plane of action 91.

FIG. 1 shows the device 1 in the position in which the forming saddle 5 is in the raised position for the minimal rounding of the spine 2 of a case for a thin book.

The forming saddle 5 could be set or adjusted not only while it is in a rest position but also while it is being raised and/or lowered.

So that a nearly gap-free transition, i.e., an almost completely smooth contact surface, is present along the top lateral surface line of the forming saddle 5, the abutting ends of the saddle blades 9, 10 are designed in the form of intermeshing rakes.

The present device 1 turns out to be especially advantageous in cases where an order requiring the continuous processing or binding of books includes books of different thicknesses, which means that the profile of the case spine must be changed during the course of processing. A change in the rounding of the case spine 2 could be handled during an ongoing work process by a control unit, which acts on the drive of the device 1 to set or to adjust the device 1.

The device 1 for forming the spine 2 of a book case 3, the spine of the case being extended more-or-less uniformly over, and aligned with, the spine of a book block and possibly comprising an inlay, comprises, on the side opposite the forming tool 4 provided for rounded book cover spines 2, a forming tool 51 like that described in EP 09 405 147.1 for flat case spines 2. The forming tool 51, which extends perpendicular to the plane of the drawing of FIG. 2 at least over the height of the case 3, comprises two support bars 53, 54, which make up the forming tool 51 and which can be raised and lowered in a more-or-less vertical direction with respect to the downward-facing, inside surface of the case spine 2, i.e., the central area of the case, and thus lift this area.

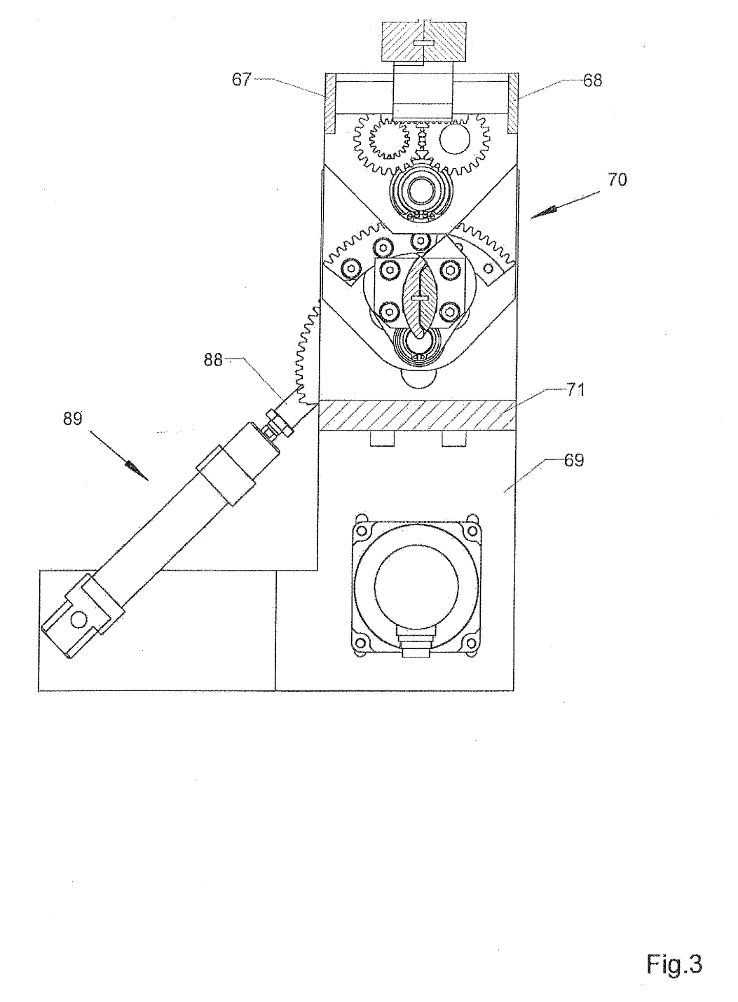

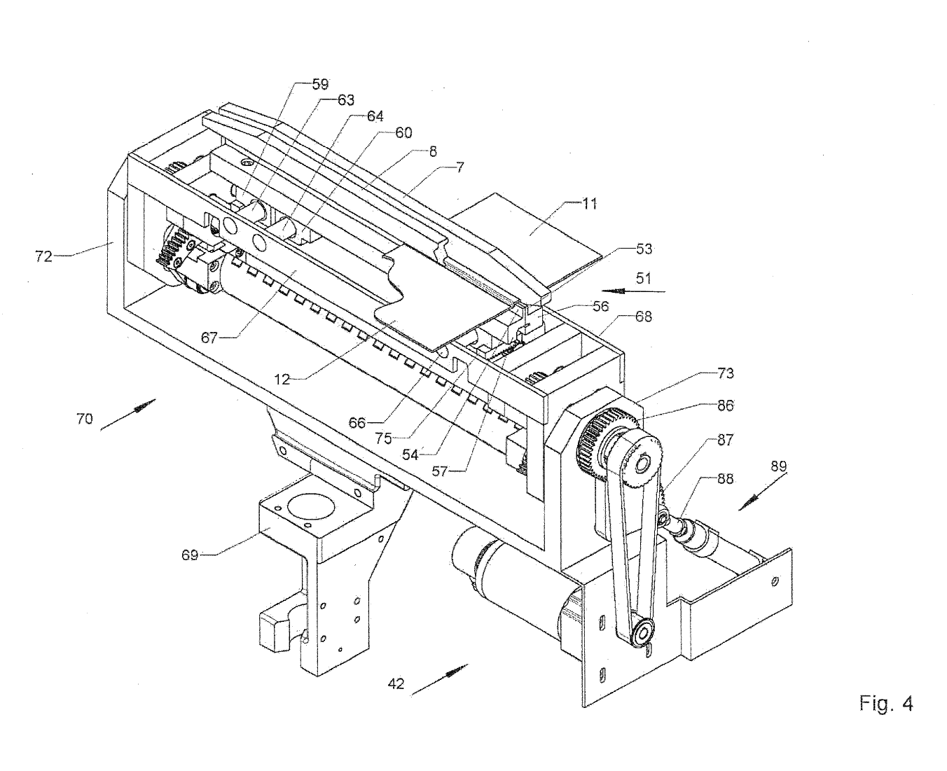

FIGS. 3 and 4 show the bar-like forming tool 51 in a working position in which the tool has been raised and has thus lifted the case spine 2 up to form a web, wherein creasing rails 7, 8 are arranged opposite each other externally of the support bars 53, 54 to crease the spine 2 and thus to form hinges between the book covers 11, 12 and the spine 2 of the case 3. The covering material of the book case 3 forms a web, which extends over the support bars 53, 54 of the bar-shaped fowling tool 51. The relatively narrow support bars 53, 54, each of which projects upward from a base shoe 56, 57, transmit the heat from heating channels 58 in the base shoes 56, 57 to the case spine 2, especially to the edge areas of the web.

The width of the support bars 53, 54 at their top ends, i.e., the side facing the inside surface of the book cover spine 2, codetermines or defines the thickness of the book blocks to be provided with a case 3; this can be derived from FIG. 4, for example. The base shoes 56, 57 lie preferably on supports 59, 60, 75, 76, each of which is free to move on a guide element 63-66 of a guide device. Each of the guide elements 63-66 of the guide devices, which for the sake of simplicity are designed as cylindrical guide rods, is attached at the ends to the side frame 67, 68 of the stand 14, which holds the device 1. The adjustable supports 59, 60, on which the base shoes 56, 67 comprising the support bars 53, 54 are laid, are supported in plain bearings or roller bearings so that they can shift longitudinally along the guide elements 63-66. The supports 59, 75 are designed with toothed racks 77, 78, each of which engages in a gear wheel 79, 80, supported on a shaft mounted in the stand 14 parallel to the creasing rails 7, 8.

The gear wheel 79 of the actuating device is driven, as shown in FIG. 5, by way of the countershaft 39, which is set into operation by the permanently seated gear wheel 44. The gear wheel 44 meshes with the gear wheel 43, which is mounted on the drive shaft 24. The drive shaft 24 is moved by the drive wheel 40, which is connected to the traveling belt 38, wherein the belt 38 passes around the pulley 41 of the rotational angle-controlled electric motor 42. The gear wheel 80, which is located on the side opposite the drive 81 of the device 1, is driven by the movements of the saddle blades 9, 10, in that the drive segments 18, 19 on the side of the machine opposite the drive side mesh with the gear wheels 49, 50, wherein the gear wheel 49 engages in a gear wheel (not visible) of the countershaft 36, on which the gear wheel 80, which also cooperates with the toothed rack 78, is mounted. As a result of the change in the rotational direction of the controlled electric motor 42, the drive segments 18, 19 are moved toward and away from each other and at the same time actuate the toothed rack drive 78, 80 provided to change the width of the web.

The rotatable frame 14 designed to hold one or more forming tools 4, 51 is supported in a bearing block 70, attached to a machine stand 69. The bearing block consists, for example, of a mounting plate 71 tightly screwed to the machine stand 69; at each end, this mounting plate has a vertical bearing plate 72, 73, in and between which the rotatable frame 14 is arranged. On the drive side, the drive shaft 24 of the one actuating device 15 passes through the bearing plate 73 and the end caps 26, 28 on one side and forms the axis of rotation 13 of the rotatable frame 14 of the forming tools 4, 51. In FIGS. 1 and 4, a gear wheel 86 is mounted on the drive shaft 24 on the outer side of the bearing plate 73 of the bearing block 70, between the bearing plate 73 and the drive wheel 40 of the drive shaft 24; this gear wheel is connected to and driven by a pivotable toothed segment 87. The latter is supported pivotably in the bearing plate 73. To a point near the toothed rim of the toothed segment 87, a piston rod 88 of a, for example, pneumatic piston-cylinder unit 89, which is attached to the machine stand 69, is hinged. The length of the toothed rim of the toothed segment 87 corresponds to at least half the circumference of the gear wheel 86, which is rigidly connected to the rotatable frame 14. The piston-cylinder unit 89 is of the double-action type and is connected to a controlled valve. In place of the piston-cylinder unit 89 and the toothed segment 87, it would also be possible to use a controlled stepping motor, acting by way of a gear wheel, to cause the gear wheel 86 to turn the rotatable frame 14.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A device for forming an outstretched, horizontally positioned spine of a case of a book, which is extended uniformly over, and aligned with, a spine of a book block, the device comprising:
two lateral opposing creasing rails;
a forming tool movable toward an inside surface of the spine of the case, the forming tool being operative to lift the case spine up between the two lateral, opposing creasing rails so as to produce at least a rounded or flat web on the spine between book covers of the case; and
a rotatable frame having an axis of rotation which is parallel to the creasing rails, the forming tool being mounted on the rotatable frame.

2. The device according to claim 1, wherein the forming tool includes at least one forming element extending parallel to the creasing rails, the forming element being formed by at least one first and one second subelement, which are adjustable to set a width of the web of the spine of the case.

3. The device according to claim 2, wherein the subelements are saddle blades with abutting ends formed as intermeshing rakes.

4. The device according to claim 1, wherein a horizontal plane formed by the axis of rotation of the rotatable frame is parallel to a plane of action of the creasing rails.

5. The device according to claim 4, wherein a vertical plane formed by the axis of rotation of the rotatable frame is equidistant from the creasing rails along the plane of action.

6. The device according to claim 1, wherein the rotatable frame is configured to allow mounting of several forming tools around the axis of rotation.

7. The device according to claims 1, wherein the rotatable frame is drivable either manually or by a motor.

8. The device according to claim 1, wherein the rotatable frame is configured so that the forming tool is replaceable.

9. The device according to claim 1, wherein the rotatable frame is configured to hold settable and adjustable forming tools.

10. The device according to claim 1, wherein the forming tools form curved and/or flat book cover spines.

11. The device according to claim 1, wherein the forming tools are distributed uniformly around the axis of rotation.

12. The device according to claim 9, wherein each of the settable forming tools is connected to and driven by at least one actuating device.

13. The device according to claim 12, wherein the forming tools are connected to, and driven by, an actuating device at both ends of the forming device.

14. The device according to claim 13, wherein the actuating device is connected to a controlled electric motor by drive shafts.

15. The device according to claim 13, wherein the actuating device mounted on a side opposite a drive for the settable forming tools is connected to, and driven by, a drive-side actuating device by way of a forming element or forming saddle of the forming tool.

16. The device according to claim 12, wherein the actuating device is a gear wheel unit or a traction drive.
